(19) United States
(12) Patent Application Publication
(10) Pub. No.: US 2014/0077776 A1
(43) Pub. Date: Mar. 20, 2014

(54) VOLTAGE REGULATOR

(71) Applicant: INTEL CORPORATION, Santa Clara, CA (US)

(72) Inventors: Don J. NGUYEN, Portland, OR (US); Vikas Shilimkar, Hillsboro, OR (US)

(73) Assignee: INTEL CORPORATION, Santa Clara, CA (US)

(21) Appl. No.: 13/621,498

(22) Filed: Sep. 17, 2012

(51) Int. Cl. G05F 1/46

(52) U.S. Cl. 323/271

(57) ABSTRACT

A voltage regulator is provided that includes a converter including a first switch transistor, a second switch transistor and a capacitor. The converter may receive a direct current (DC) voltage and may provide a voltage to the capacitor. The converter may operate as a buck converter and the converter may operate as a boost converter. The voltage regulator may also include a voltage controller to control the converter to operate as the buck converter or as the boost converter.

### BACKGROUND

1. Field

Embodiments may relate to a voltage regulator for an electronic device.

2. Background

Electronic devices (or platform loads) may be powered by a battery and a voltage regulator. Voltage regulator (VR) losses may be major contributors in total platform power loss. Residency (or probability) of a voltage regulator output current may show where this power is lost most of the time. For example, approximately 50% of the time, the voltage regulator may operate at an idle condition. An idle condition may be a no load condition or a low load condition. Electronic devices may be idle for a significant portion of the battery life. One contributor for voltage regulator high power losses may be a switching loss in direct current (DC)-direct current (DC) buck type voltage regulators.

### BRIEF DESCRIPTION OF THE DRAWINGS

Arrangements and embodiments may be described in detail with reference to the following drawings in which like reference numerals refer to like elements and wherein:

FIG. 1 shows an example of an electronic device;

FIG. 2 shows an example of a power system for an electronic device (or platform load);

FIG. 3 shows a voltage regulator according to an example arrangement;

FIG. 4 shows a voltage regulator according to an example embodiment; and

FIG. 5 shows a battery system according to an example arrangement.

### DETAILED DESCRIPTION

In the following detailed description, like reference numerals may be used to designate identical, corresponding and/or similar components in differing figure drawings. Further, in the detailed description to follow, example sizes/models/values/ranges may be provided although embodiments are not limited to the same. Where specific details are set forth in order to describe example embodiments, it should be apparent to one skilled in the art that embodiments may be practiced without these specific details.

In the following description, signals may be described as being asserted. This may correspond to being a HIGH signal (or a 1). Signals may also be described as being de-asserted. This may correspond to being a LOW signal (or a 0).

An electronic device (also hereafter referred to as a platform load) may receive a direct current (DC) voltage from a voltage regulator (VR). The voltage regulator may be provided external of the electronic device or the platform load. The DC voltage may be provided from a battery and/or a battery pack.

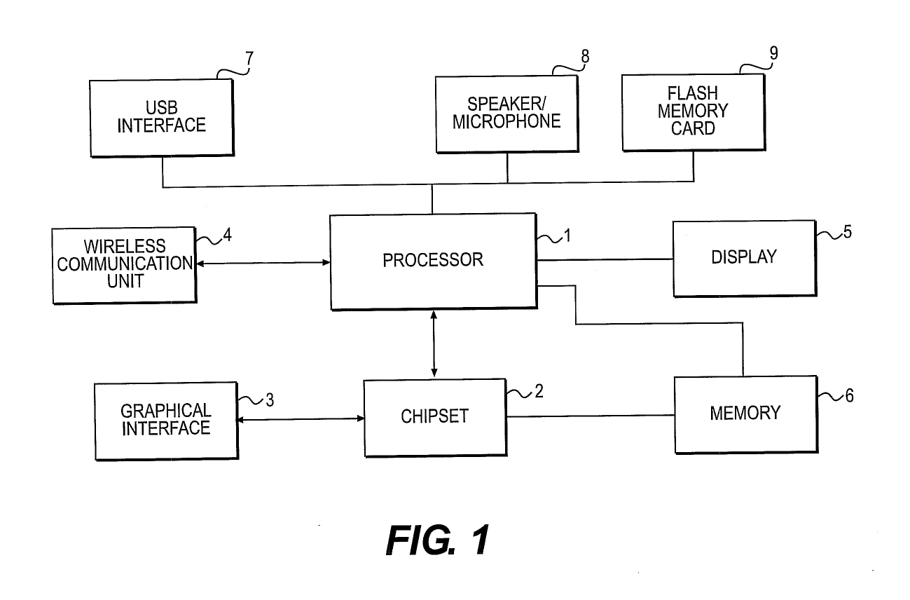

FIG. 1 shows an example of an electronic device. Other configurations may also be provided. The electronic device (or platform load) may be any one of a number of battery-powered devices, such as, but not limited to, a mobile phone, a smartphone, a personal digital assistant, a media player, and/or a laptop or notebook computer. Alternatively, the electronic device may be an AC-powered device that is usually used at a fixed location such as a desktop computer, a television, a digital video disc (DVD) or other type of media player, surround-sound and/or other media receiver just to name a few.

As shown in FIG. 1, the electronic device may include a processor 1, a chipset 2, a graphical interface 3, a wireless communications unit 4, a display 5, a memory 6, and a plurality of functional circuits including a universal serial bus (USB) interface 7, speaker and microphone circuits 8, and a flash memory card 9. A media player may also be provided. In other embodiments, a different combination or arrangements of circuits and functions may be included.

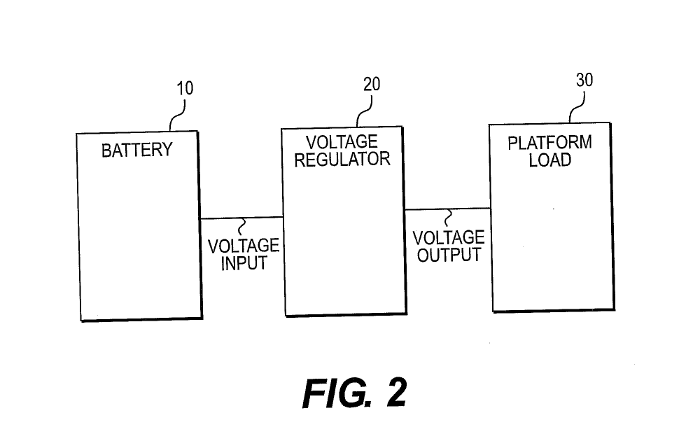

FIG. 2 shows an example of a power system for an electronic device (or a platform load). Other configurations may also be provided. The features of FIG. 2 may also be considered an apparatus, a system and/or an electronic device.

FIG. 2 shows that a battery 10 may provide a direct current (DC) voltage (or voltage input) to a voltage regulator (VR) 20. The voltage regulator 20 may adjust the received voltage input to a voltage output, which may then be provided to a platform load 30 (or electronic device). The power system may include the voltage regulator 20 and the battery 10. The voltage regulator 20 may provide a DC voltage to the platform load 30, which is an electronic device.

Arrangements may use a capacitor(s) or super-capacitor(s) to store and/or supply a power during light load conditions. Embodiments may recycle energy stored in output capacitors to a battery, a battery pack and/or a current sink on a battery rail.

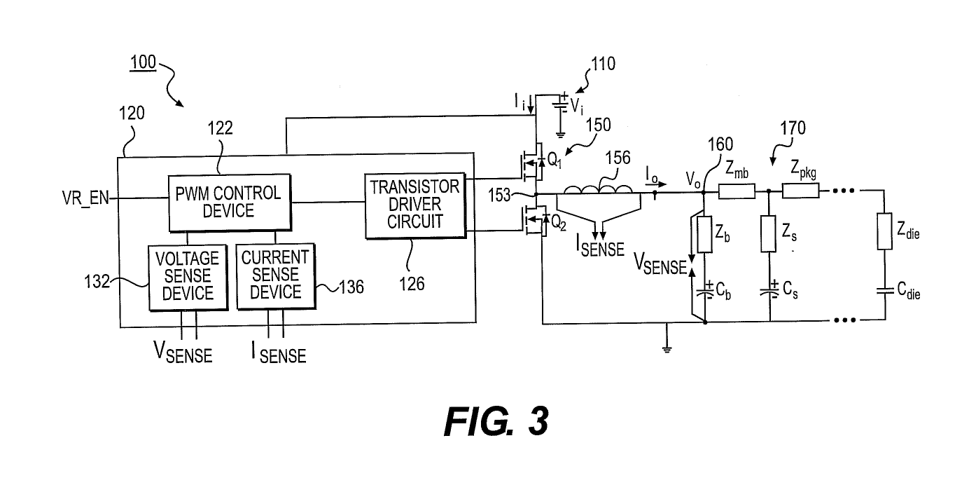

FIG. 3 shows a voltage regulator according to an example arrangement. Other arrangements and configurations may also be provided. The voltage regulator shown in FIG. 3 may correspond to the voltage regulator 20 shown in FIG. 2. The features of FIG. 3 may also be considered as part of an apparatus, a system and/or an electronic device.

More specifically, FIG. 3 shows a voltage regulator 100 that includes a voltage controller 120, a buck converter 150 and a super-capacitor device 170 (or capacitor device). The voltage regulator 100 may be coupled to a battery 110, which may correspond to the battery 10 of FIG. 2. The battery 110 may provide a DC voltage (Vᵢ) to the voltage regulator 100.

The voltage regulator 100 may also be called a voltage regulator module (VRM).

The voltage regulator 100 (and more specifically, the voltage controller 120) may include a pulse width modulation (PWM) control device 122, a transistor driver circuit 126 (or a field effect transistor (FET) driver), a voltage sense device 132, and a current sense device 136. Although not shown, the voltage regulator 100 may also include a capacitor control device (or super-capacitor device), and/or an idle control device.

The buck converter 150 may include a first switch transistor Q₁, a second switch transistor Q₂, an inductor 156, and a capacitor C_{b}. The inductor 156 and the capacitor C_{b} may form a filter of the buck converter 150. Each of the first switch transistor Q₁ and the second switch transistor Q₂ may be a field effect transistor (FET). As shown in FIG. 3, the first switch transistor Q₁ and the second switch transistor Q₂ are coupled in series between the battery 110 and a ground.

A middle node 153 between the first switch transistor Q₁ and the second switch transistor Q₂ is coupled to a first end of the inductor 156. A second end of the inductor 156 may be considered an output node 160 that may provide an output voltage V₀ to the platform load (or the electronic device).

As shown in FIG. 3, the capacitor C_{b} of the buck converter 150 may be coupled between the output node 160 and ground. A first end of the capacitor C_{b} may be coupled (via an impedance Z_{b}) to the second end of the inductor 156 (i.e., the output node 160). A second end of the capacitor C_{b} may be coupled to ground.

The buck converter 150 may provide feedback signals to the voltage controller 120 so that the voltage controller 120 may control the buck converter 150. For example, first feedback signals I_{SENSE} may be a voltage across the first end of the inductor 156 (or the node 153) and the second end of the inductor 156 (or the node 160). The first feedback signals I_{SENSE} may be an input to the current sense device 136 of the voltage controller 120. The current sense device 136 may receive feedback signals indicative of current in the buck converter 150.

The buck converter 150 may further provide second feedback signals V_{SENSE} based on a voltage at the output node 160 (between the inductor 156 and the capacitor C_{b}) and ground. The second feedback signals V_{SENSE} may be input to the voltage sense device 132 of the voltage controller 120. The voltage sense device 132 may receive feedback signals indicative of the output voltage. The second feedback signals may also be received from the platform load.

The voltage sense device 132 may receive the second feedback signals V_{SENSE} indicative of the output voltage Vₒ. The current sense device 136 may receive the first feedback signals I_{SENSE} indicative of current in the buck converter 150 (i.e., current through the inductor 156).

The second feedback signals V_{SENSE} and the first feedback signals I_{SENSE} may help stabilize the output voltage Vₒ of the voltage regulator 100 to within a desired tolerance. The first feedback signals I_{SENSE} may also help protect the voltage regulator 100 from over current conditions.

The voltage sense device 132 may provide an output signal to the PWM control device 122, and the current sense device 136 may provide an output signal to the PWM control device 122. The PWM control device 122 may receive signals from the voltage sense device 132 and the current sense device 136.

The transistor driver circuit 126 may provide driving signals to control the first switch transistor Q₁ and the second switch transistor Q₂ of the buck converter 150. More specifically, the transistor driver circuit 126 may apply pulse width modulation signals (or driving signals) to the first and second switch transistors Q₁, Q₂ of the buck converter 150. A width of the signals (or driving signals) may control timing of the first and second switch transistors Q₁, Q₂. The driving signals may be adjusted (or provided) based on the feedback signals.

The super-capacitor device 170 may include a capacitor Cₛ connected through a parasitic element Zₛ. The element Zₛ may represent parasitic resistance and inductance of the interconnect and the capacitor Cₛ. FIG. 3 shows on-die decoupling capacitor(s) C_{die}. Additionally, elements Z_{mb}, Z_{pkg} and Z_{die} may represent parasitic impedances of a motherboard, a package and a die, respectively.

A first input signal VR_EN may be provided to the voltage controller 120. The first input signal VR_EN may represent turning on or off of the platform load. The first input signal VR_EN may be HIGH when the platform load is powered ON, and the first input signal VR_EN may be LOW when the platform load is not powered ON.

FIG. 3 shows that the buck converter 150 may receive a DC voltage Vᵢ from the battery 110. FIG. 3 shows the current Iᵢ from the battery 110 to the buck converter 150. The buck converter 150 may provide the output voltage Vₒ at the node 160. The output voltage Vₒ may be provided to a platform load. The voltage controller 120 may receive feedback signals from the buck converter 150. The voltage controller 120 may provide driving signals to the first and second switch transistors Q₁, Q₂ based on the feedback signal(s).

The first and second switch transistors Q₁, Q₂ may be controlled by the voltage controller 120 so that power from the battery 110 may be provided to the platform (i.e., shown as the voltage Vₒ at the node 160).

The first and second switch transistors Q₁ and Q₂ may operate as a buck converter to step down the voltage Vᵢ from the battery 110 and provide the output voltage Vₒ at the node 160. FIG. 3 shows current Iᵢ from the battery 110 that passes through the first switch transistor Q₁ and the inductor 156, and may be provided as current Iₒ.

The buck converter (or the first switch transistor Q₁) may be turned OFF when the load or the platform is no longer to be provided. This may discharge the voltage in the capacitors C_{b}, Cₛ and C_{die}.

More specifically, at a power ON of the voltage regulator 100, all capacitors in a power delivery network (PDN) may be charged to the output voltage Vₒ. That is, energy stored in the battery 110 may be transferred to the capacitors C_{b}, Cₛ, . . . , C_{die}. When the VR_EN signal is deasserted (or turned OFF), the output rail (at the node 160) may be discharged through the second switch transistor Q₂ or a discharge transistor on the platform.

When a power rail is turned off, a voltage on the rail may be forced to zero by turning the voltage regulator OFF and shorting the rail to ground through a transistor on the platform. However, this may result in a loss of energy stored in capacitors on the rails. During a wake-up event, all the capacitors on the power delivery network may be charged to bring back the rails to a specified voltage level. However, this may result in loss of energy during power cycling of voltage regulators.

Embodiments may recycle energy stored in output capacitors to a battery, a battery pack and/or other load(s) on a platform. The voltage regulator may be used as a boost converter to boost a voltage regulator (VR) output capacitor voltage to a battery voltage level. The energy stored in the capacitor(s) may be transferred to the battery (and/or battery pack) and the battery may be recharged. The energy stored in the capacitor(s) may be transferred to another load.

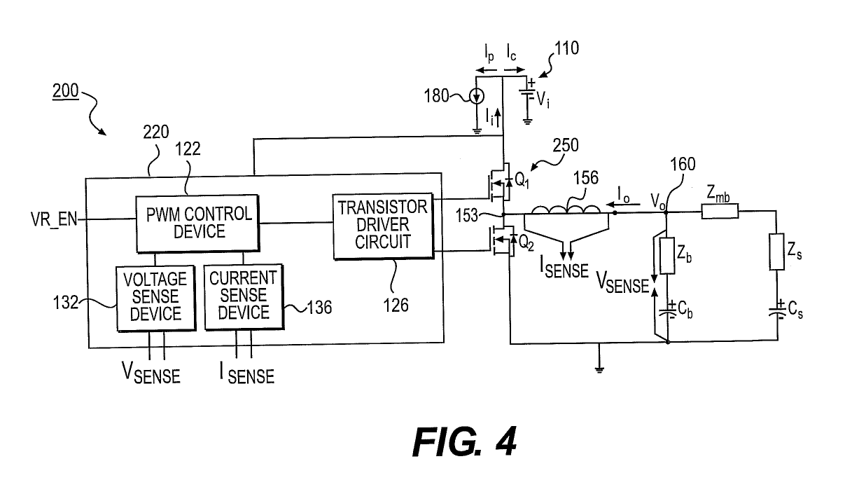

FIG. 4 shows a voltage regulator according to an example embodiment. Other embodiments and configurations may also be provided.

FIG. 4 shows a voltage regulator 200 that includes a voltage controller 220 and a converter 250 (or a buck/boost converter). The voltage regulator 200 shown in FIG. 4 may correspond to the voltage regulator 100 shown in FIG. 3 and/or the voltage regulator 20 shown in FIG. 2. The converter 250 may operate as a buck converter when (or while) providing current (or power) to the capacitor Cₛ, and the converter 250 may operate as a boost converter when (or while) providing current (or power) back to the battery 110. The current source 180 shown in FIG. 4 may represent current provided to a platform load. The converter 250 operating as the buck converter may provide energy to at least one of the battery 110 and a load (i.e., shown as the current source 180).

The voltage regulator 200 may also be called a voltage regulator module (VRM).

The voltage regulator 200 (and more specifically, the voltage controller 220) may include the pulse width modulation (PWM) control device 122, the transistor driver circuit 126 (or a field effect transistor (FET) driver), the voltage sense device 132, and the current sense device 136. Although not shown, the voltage regulator 200 may also include a capacitor control device (or super-capacitor device), and/or an idle control device.

The converter 250 may include the first switch transistor Q₁, the second switch transistor Q₂, the inductor 156, and the capacitor C_{b}. The inductor 156 and the capacitor C_{b} may form a filter of the buck converter 250. Each of the first switch transistor Q₁ and the second switch transistor Q₂ may be a field effect transistor (FET). As shown in FIG. 4, the first switch transistor Q₁ and the second switch transistor Q₂ are coupled in series between the battery 110 and a ground.

The voltage regulator 200 may include a super-capacitor device, such as the super-capacitor device 170 shown in FIG. 3. The super-capacitor device may include the capacitor Cₛ to store energy (or a voltage) received from the battery 110. Other capacitors may also be provided.

The middle node 153 between the first switch transistor Q₁ and the second switch transistor Q₂ is coupled to the first end of the inductor 156. The second end of the inductor 156 may be considered the output node 160 that may provide the output voltage V₀ to the platform load (or the electronic device).

As shown in FIG. 4, the capacitor C_{b} of the converter 250 may be coupled between the output node 160 and ground. The first end of the capacitor C_{b} may be coupled (via the parasitic impedance Z_{b}) to the second end of the inductor 156 (i.e., the output node 160). The second end of the capacitor C_{b} may be coupled to ground.

The converter 250 may provide feedback signals to the voltage controller 220 so that the voltage controller 220 may control the converter 250. For example, first feedback signals I_{SENSE} may be a voltage across the first end of the inductor 156 (or the node 153) and the second end of the inductor 156 (or the node 160). The first feedback signals I_{SENSE} may be an input to the current sense device 136 of the voltage controller 220. The current sense device 136 may receive feedback signals indicative of current (in the converter 250).

The converter 250 may further provide second feedback signals V_{SENSE} based on a voltage at the output node 160 (between the inductor 156 and the capacitor C_{b}) and ground. The second feedback signals V_{SENSE} may be input to the voltage sense device 132 of the voltage controller 220. The voltage sense device 132 may receive feedback signals (indicative of the output voltage). The second feedback signals may also be taken from the platform load.

The voltage sense device 132 may receive the second feedback signals V_{SENSE} indicative of the output voltage Vₒ. The current sense device 136 may receive the first feedback signals I_{SENSE} indicative of current (i.e., current through the inductor 156).

The second feedback signals V_{SENSE} and the first feedback signals I_{SENSE} may help stabilize the output voltage Vₒ of the voltage regulator 200 to within a desired tolerance. The first feedback signals I_{SENSE} may also help protect the voltage regulator 200 from over current conditions.

The voltage sense device 132 may provide an output signal to the PWM control device 122, and the current sense device 136 may provide an output signal to the PWM control device 122. The PWM control device 122 may receive signals from the voltage sense device 132 and the current sense device 136.

The transistor driver circuit 126 may provide driving signals to control the first switch transistor Q₁ and the second switch transistor Q₂ of the converter 250. More specifically, the transistor driver circuit 126 may apply pulse width modulation signals (or driving signals) to the first and second switch transistors Q₁, Q₂ of the converter 250. The width of the signals (or driving signals) may control timing of the first and second switch transistors Q₁, Q₂. The driving signals may be adjusted (or provided) based on the feedback signals. The voltage controller 220 may change a duty cycle of the converter 250 based at least in part on at least one of the feedback signals.

The first input signal VR_EN may be provided to the voltage controller 220. The first input signal VR_EN may represent turning on or off of the platform load. The first input signal VR_EN may be HIGH when the platform load is powered ON, and the first input signal VR_EN may be LOW when the platform load is not powered ON.

The converter 250 may receive a DC voltage Vᵢ from the battery 110. A current may be provided from the battery 110 to the converter 250. The converter 250 may provide the output voltage Vₒ at the node 160. The output voltage Vₒ may be provided to a platform load. The voltage controller 220 may receive feedback signals from the converter 250. The voltage controller 220 may provide driving signals to the first and second switch transistors Q₁, Q₂ based at least in part on the feedback signal(s). The driving signals may be provided based at least in part on the feedback signals and a battery node voltage.

The first and second switch transistors Q₁, Q₂ may be controlled by the voltage controller 220 so that power (or energy) from the battery 110 may be provided to the platform (i.e., shown as the voltage Vo at the node 160).

The first and second switch transistors Q₁ and Q₂ may operate as a buck converter to step down (or reduce) the voltage Vᵢ from the battery 110 and provide the output voltage Vₒ at the node 160. When the converter 250 is operating as the buck converter, the current from the battery 110 may pass through the first switch transistor Q₁ and the inductor 156, and may provide power (or energy) to the capacitors C_{b}, Cₛ.

The voltage regulator 200 may be turned ON and OFF during power saving cycles (sleep modes). The converter 250 may be used as a buck converter and as a boost converter during voltage regulator (VR) power cycling. For example, a voltage across the charged capacitors C_{b}, Cₛ may be used as an input to the converter 250 operating as a boost converter.

The voltage regulator 220 may sense voltage and/or current from the battery 110, such as at least in part by the feedback signals. When the first input signal VR_EN is disasserted, the PWM control device 122 and the transistor driver circuit 126 may control the first and second switch transistors Q₁, Q₂ such that power is returned to the battery 110 (and/or other load components) based on the feedback signals. That is, the transistor driver circuit 126 may treat the output power stage (i.e., the switch transistors Q₁, Q₂ and inductor 156) as a boost converter. The boost converter may discharge the voltage (or energy) from the capacitors to the battery 110. FIG. 4 shows a current Iᵢ from the capacitors that passes through the converter 250 and is provided as current Iᵢ. The current Iᵢ may be used as a current I_{c} to the battery 110 and/or a current Iₚ to a platform load.

The voltage sense device 132 and the current sense device 136 may be used to determine a duty cycle of the converter 250 so as to operate as the boost converter. Additionally, battery packs may need to be charged with a constant current. This may be determined by a battery charge rate. The charge rate may be controlled by using the Iₛₑₙₛₑ feedback signals.

The converter 250 may operate as a buck converter when the voltage regulator 200 is to provide an output power (i.e., the first input signal VR_EN is HIGH). On the other hand, the converter 250 may operate as a boost converter when the voltage regulator 200 is to not provide an output power, such as when an electronic device is to be provided in a sleep mode or idle mode.

The converter 250 may operate as the buck converter and provide the voltage to the voltage capacitors when the first switch transistor Q₁ is enabled and the second switch transistor Q₂ is disabled. The converter may operate as the boost converter and provide the voltage from the capacitors to the battery or to another load when the first switch transistor Q₁ is disabled and the second switch transistor Q₂ is enabled.

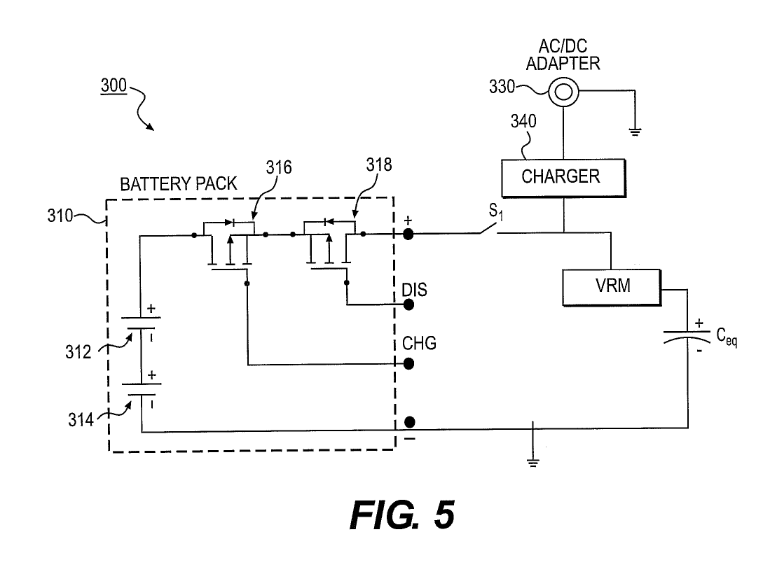

FIG. 5 shows a battery system according to an example embodiment. Other embodiments and configurations may also be provided. The battery system 300 shown in FIG. 5 may be provided to a notebook system, a netbook system, a tablet system, a smartphone platform and/or other systems.

The battery system 300 may include a battery pack 310, an AC/DC adapter 330, a charger 340 and a voltage regulator module (VRM) 350. The VRM 350 may correspond to the voltage regulator 200 shown in FIG. 4, for example.

The battery pack 310 may include battery cells 312, 314 as well as switches 316, 318. The switch 316 may be a charge switch that operates based on a charge (CHG) signal. The switch 318 may be a discharge switch that operates based on a discharge (DIS) signal. The CHG signal and the DIS signal may be generated by a firmware controller in the platform as part of a power management feature.

The AC/DC adapter 330 may be coupled to the charger 340 so as to provide an appropriate power. The power may be used to charge the battery pack 310 when a switch S1 is closed. The switch S₁ may operate into a linear mode and a trickle charge or continuous charge mode may be provided.

FIG. 5 also shows a capacitor C_{eq} (or equivalence capacitor) that represents all the charged capacitors, such as shown in FIG. 4.

In an example of a smartphone (or smartphone platform), the switch S₁ may not be provided and/or may not be used. In this example, a charge control may be provided by operating the charge switch 316 and the discharge switch 318 within the battery pack 310 into a linear mode of operation. This may achieve an appropriate battery charge characteristic.

Embodiments may provide a method of powering an electronic device, a system and/or an apparatus. This may include receiving an input voltage at the voltage regulator 200, operating the converter 250 (of the voltage regulator 200) as a buck converter, providing the output voltage Vₒ from the voltage regulator 200, and charging capacitor(s) of the voltage regulator 200. The voltage (or energy) in the capacitor(s) may be discharged by using the converter 250 as a boost converter. The discharged voltage may be provided from the capacitor(s) to the battery 110 and/or other loads of the platform.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A voltage regulator comprising:
a converter to receive a direct current (DC) voltage and to provide a voltage to a capacitor when the converter is to operate as a buck converter, and the converter to discharge the voltage from the capacitor to at least one of a battery and a load when the converter is to operate as a boost converter; and
a voltage controller to control the converter to operate as the buck converter, and the voltage controller to control the converter to operate as the boost converter based at least in part on at least one feedback signal.

2. The voltage regulator of claim 1, wherein the voltage controller to change a duty cycle of the converter based at least in part on the at least one feedback signal.

3. The voltage regulator of claim 1, wherein the converter to operate as the buck converter when the voltage regulator is to provide an output power.

4. The voltage regulator of claim 3, wherein the converter to operate as the boost converter when the voltage regulator is not to provide an output power.

5. The voltage regulator of claim 1, wherein the converter includes a first switch transistor, a second switch transistor and the capacitor.

6. The voltage regulator of claim 5, wherein the converter is to operate as the buck converter and provide the voltage to the capacitor when the first switch transistor is enabled and the second switch transistor is disabled.

7. The voltage regulator of claim 6, wherein the converter is to operate as the boost converter and provide the voltage from the capacitor to the battery or the load when the first switch transistor is disabled and the second switch transistor is enabled.

8. The voltage regulator of claim 5, wherein the voltage controller includes a voltage sense device and a current sense device, the voltage sense device to receive at least one feedback signal indicative of an output voltage, and the current sense device to receive at least one feedback signal indicative of current.

9. The voltage regulator of claim 8, wherein the voltage controller further includes a pulse width modulation control circuit and a transistor driver circuit to provide a first driving signal to the first switch transistor and to provide a second driving signal to the second switch transistor based at least in part on the at least one feedback signal.

10. An electronic device comprising:
a platform load having a processor, and
a voltage regulator to provide an output voltage to the platform load and to provide a voltage to at least one of a battery and a load, the voltage regulator including:
a converter to receive a direct current (DC) voltage and to provide the output voltage to the platform load when the converter is to operate as a buck converter, and the converter to provide the voltage from a capacitor to the at least one of the battery and the load when the converter is to operate as a boost converter; and
a voltage controller to control the converter to operate as the buck converter or to operate as the boost converter based at least in part on at least one feedback signal.

11. The electronic device of claim 10, wherein the converter to change a duty cycle of the converter based at least in part on the at least one feedback signal.

12. The electronic device of claim 10, wherein the converter to operate as the boost converter when the processor is to be provided in a sleep mode.

13. The electronic device of claim 9, wherein the converter includes a first switch transistor, a second switch transistor and the capacitor.

14. The electronic device of claim 13, wherein the converter is to operate as the buck converter when the first switch transistor is enabled and the second switch transistor is disabled.

15. The electronic device of claim 14, wherein the converter is to operate as the boost converter when the first switch transistor is disabled and the second switch transistor is enabled.

16. The electronic device of claim 13, wherein the voltage controller includes a voltage sense device and a current sense device, the voltage sense device to receive at least one feedback signal indicative of the output voltage, and the current sense device to receive at least one feedback signal indicative of current.

17. The electronic device of claim 16, wherein the voltage controller further includes a pulse width modulation control circuit and a transistor driver circuit to provide a first driving signal to the first switch transistor and to provide a second driving signal to the second switch transistor based at least in part on the at least one feedback signal.

18. A method of powering an electronic device comprising:
receiving an input voltage at a voltage regulator having a converter;
providing, to a platform of the electronic device, an output voltage from the voltage regulator operating as a buck converter;
providing energy to a capacitor while operating the converter as the buck converter;
discharging the energy in the capacitor while operating the converter as a boost converter; and
providing the discharged energy to at least one of a battery and a load of the electronic device.

19. The method of claim 18, wherein providing the output voltage includes enabling a first switch transistor of the converter and disabling a second switch transistor of the converter.

20. The method of claim 19, wherein discharging the energy includes disabling the first switch transistor of the converter and enabling the second switch transistor of the converter.
